(19) United States
(12) Patent Application Publication
(10) Pub. No.: US 2013/0266943 A1
(43) Pub. Date: Oct. 10, 2013

(54) COMPOSITIONS AND METHODS FOR ADHESION-BASED CELL SORTING

(71) Applicants: Heather Powell, Mason, OH (US); John Lannutti, Grove City, OH (US); Britani Blackstone, Hilliard, OH (US)

(72) Inventors: Heather Powell, Mason, OH (US); John Lannutti, Grove City, OH (US); Britani Blackstone, Hilliard, OH (US)

(21) Appl. No.: 13/836,137

(22) Filed: Mar. 15, 2013

Related U.S. Application Data
(60) Provisional application No. 61/620,630, filed on Apr. 5, 2012.

(51) Int. Cl. G01N 1/34

(52) U.S. Cl. CPC G01N 1/34
USPC 435/6.11; 435/29; 435/6.12; 435/7.1; 530/356; 528/271; 428/401; 428/478.2; 428/435; 428/411.1; 428/426

(57) ABSTRACT

In an aspect, provided is an apparatus for sorting cells. The device may include polymer nanofibers treated with gaseous plasma. The nanofibers may comprise at least one of polycaprolactone and collagen. The gaseous plasma may comprise at least one of CF₄, oxygen, argon, nitrogen, and air. In a further aspect, provided are methods of sorting cells in a composition. The method may include providing a substrate comprising polymer nanofibers that have been pretreated with a gaseous plasma, contacting the polymer nanofibers with a composition comprising a plurality of cells, and applying a force to the polymer nanofibers. In another aspect, provided are methods of making a device for sorting cells. The method may include applying a composition comprising at least one polymer onto a surface by electrospinning to form polymer nanofibers, and exposing the polymer nanofibers to a gaseous plasma to produce treated polymer nanofibers.

### CROSS-REFERENCE TO RELATED APPLICATIONS

This application claims priority to U.S. Provisional Patent Application No. 61/620,630, filed Apr. 5, 2012, which is incorporated herein by reference in its entirety.

### STATEMENT REGARDING FEDERALLY SPONSORED RESEARCH

This invention was made with government support under grants EEC-0914790 and CMMI-0928315 awarded by the United States National Science Foundation. The government has certain rights in the invention.

### INTRODUCTION

Properties common to metastatic cancers are local invasion and distant spread, though causative factors and molecular composition may differ greatly. Decades of clinical practice have indicated that standard treatment regimens are often not effective for specific components of the tumor cell population. This has shifted cancer therapy from a general, “one drug fits all” approach toward more personalized medicine. The ability to predict individual patient response and optimize chemotherapeutic drug choice, adjuvant therapies, and appropriate dosing could greatly increase effectiveness. However, personalized cancer treatments require swift, accurate, and efficient diagnostics to assess disease states. Isolating patient cells of interest from biopsies is important to such diagnostics as the collected and analyzed cells will determine the course of treatment.

Solid malignant tumors are heterogeneous masses whose composition is determined by the location of origin. Cells that comprise such tumors can include normal cell types, such as endothelial cells and fibroblasts, and cancer cells of multiple phenotypes, the latter of which must be effectively sorted from this initial mixed population for effective treatment development. Conventional cell sorting techniques, i.e., fluorescence or magnetic-activated cell sorting (FACS or MACS)-rely upon labeling cells with either beads or dyes for separation. Recent improvements have not yet been widely adopted as the cost and size of the supporting equipment and the skill levels required limit widespread accessibility. Furthermore, a label specific to the cell of interest must be predetermined in order for it to be discerned from the population. The labeling process may alter the cell function but, more importantly, cancer cells of potential interest can be missed if they are not part of the specific cancer phenotype that was labeled.

Such label-free cell sorting efforts seek to exploit differentials that exist between cells such as cell density, size, dielectric properties and refractive index. While label-free techniques can achieve efficiency or purity of 90% or greater, many are limited by small sample sizes and require either bulky or expensive supporting equipment or complex nanofabrication techniques. There is a need to develop an inexpensive, high-throughput platform to sort cancer cells.

### SUMMARY

In an aspect, the disclosure relates to an apparatus for sorting cells. The device may include polymer nanofibers treated with gaseous plasma. In some embodiments, the nanofibers comprise at least one of polycaprolactone (PCL) and collagen. In some embodiments, the gaseous plasma comprises at least one of CF₄, oxygen, argon, nitrogen, and air. The nanofibers may have a diameter of about 50 nm to about 500 nm. The nanofibers may be associated with a planar surface. In some embodiments, the planar surface comprises glass or polymer.

In a further aspect, the disclosure relates to methods of sorting cells in a composition. The method may include providing a substrate comprising polymer nanofibers that have been pretreated with a gaseous plasma, contacting the polymer nanofibers with a composition comprising a plurality of cells, and applying a force to the polymer nanofibers. In some embodiments, the plurality of cells comprises a mixed population of cancer cells and non-cancer cells. In some embodiments, the plurality of cells comprises a mixed population of metastatic cancer cells and non-metastatic cancer cells. Applying a force may include applying a fluid flow. In some embodiments, the fluid flow may be applied with a force of about 5 dynes/cm² to about 500 dynes/cm². In some embodiments, the force may be applied for about 1 min to about 10 min. Contacting may include incubating the composition with the polymer nanofibers. In some embodiments, the polymer nanofibers and the composition may be incubated together for about 30 min to about 24 hours. The method may further include collecting a first fraction of cells removed from the polymer nanofibers by the force applied to the polymer nanofibers. Collecting may include washing the first fraction from the device. In some embodiments, a second fraction of cells remains adhered to the polymer nanofibers after applying the force. In some embodiments, when the composition comprises cancer cells and non-cancer cells, the first fraction may comprise at least about 60% of the cancer cells, and the second fraction comprises at least about 60% of the non-cancer cells. In some embodiments, when the composition comprises metastatic cancer cells and non-metastatic cancer cells, the first fraction may comprise at least about 60% of the metastatic cancer cells, and the second fraction may comprise at least about 60% of the non-metastatic cancer cells. The cancer cells may comprise breast cancer cells. In some embodiments, the cells in the first fraction are viable after collection. In some embodiments, the method further comprises subsequently analyzing the cells in the first fraction with a technique selected from PCR, Western Blot, Northern Blot, Southern Blot, immunohistochemistry, or FACS.

In another aspect, the disclosure relates methods of making a device for sorting cells. The method may include applying a composition comprising at least one polymer onto a surface by electrospinning to form polymer nanofibers, and exposing the polymer nanofibers to a gaseous plasma to produce treated polymer nanofibers. In some embodiments, electrospinning of the composition is conducted at a rate of about 2 mL/hour to about 20 mL/hour and at an electric potential of about 10 kV to about 30 kV. In some embodiments, the polymer nanofibers are exposed to the gaseous plasma at a plasma radio frequency of about 5 MHz to about 15 MHz and for a period of about 1 min to about 30 min. The disclosure provides for other aspects and embodiments that will be apparent in light of the following detailed description and accompanying Figures.

### BRIEF DESCRIPTION OF THE DRAWINGS

FIG. 1 is a finite element mesh of the rough nanofiber surface for fluid flow modeling.

FIG. 2 are scanning electron micrographs of as-spun electrospun PCL (A) and PCL after plasma-treatment with (B) air and (C) CF₄. Scale bar=500 nm.

FIG. 3 is a graph of contact angle of water droplets on as-spun electrospun PCL and PCL plasma-treated with air and CF₄ plasma.

FIG. 4 are graphs showing results from an MTS proliferation assay of (A) primary human fibroblasts, (B) primary human epidermal keratinocytes, and (C) human breast cancer carcinomas cultured on air or CF₄ plasma-treated electrospun PCL scaffolds.

FIG. 5 are confocal images of human keratinocytes, human fibroblasts, and MCF-7 cells cultured on air and CF₄ plasma-treated PCL scaffolds. Cell morphology is shown after 1 and 24 hours of culture. (Blue=nuclei, green=actin) Scale bar=50 μm.

FIG. 6 are graphs showing cell area as a function of culture time and PCL fiber surface treatment for (A) fibroblasts, (B) keratinocytes, and (C) MCF-7 breast cancer cells.

FIG. 7 are velocity fringe and shear rate contours for the nanofiber-based rough mesh. Dashed box indicates imaging area for the strength of adhesion testing.

FIG. 8 are graphs of strength of cell adhesion to air and CF₄ plasma-treated electrospun PCL fibers. Cells were exposed to 200, 275, and 350 dynes/cm² of shear stress for 5 min. Percent of cells remaining after the exposure to shear stress shown for (A) fibroblasts, (B) keratinocytes, and (C) MCF-7 breast cancer cells. (D) Direct comparison of adhesion strength between cell types on CF₄ plasma-treated electrospun fibers. Note that the MCF-7 cancer cells are very sensitive to shear stress while the epithelial and mesenchymal cell types adhere much more strongly with no change in percent of cells remaining between any of the shear stress levels. (E) Images of different cell type after exposure to shear stress on fibers treated with air or CF₄.

FIG. 9 are representative confocal images of mixed populations of cells, fibroblasts (green), keratinocytes (red), and MCF-7 breast cancer cells (blue), seeded onto CF₄ plasma-treated PCL fibers (A). Preferential removal of MCF-7 cells from the mixed population after exposure to 350 dynes of shear stress for 5 minutes (B).

FIG. 10 is a graph showing results and images of cells for (A) MTS assay of MCF-7 cell metabolisms one hour and 24 hours after removal from CF₄ plasma-treated PCL fibers using 200 and 350 dynes/cm² shear stress versus MCF-7 cells that were not subjected to shear stress (0 dynes/cm²). Brightfield images of the sorted population after 24 hours in culture. (B) Control pure MCF-7 population, (C) 200 dynes/cm², and (D) 350 dynes/cm². All cells observed exhibited MCF-7 morphology. Cell fragments were sparse in the 200 dynes/cm² group but more prevalent in the 350 dynes/cm².

FIG. 11 is a graph showing the proportion of cells remaining adhered to a collagen-plasma fiber after treatment with 300 dynes/cm² of shear stress.

### DETAILED DESCRIPTION

The inventors have discovered an inexpensive, high-throughput, electrospun fiber-based platform to sort cells based on adhesion. For example, the compositions and methods described herein may be used to sort or separate cancer cells, as cancer cells tend to exhibit weaker adhesion than normal non-cancer cells. As detailed herein, cancer cells were sorted from normal cells based on their strength of adhesion, stemming from the characteristic of cancer cells to exhibit decreased adhesion from native cells. First viability, spreading, and strength of adhesion of primary human breast epithelial and fibroblast cells and MFC-7 cancer cells were quantified as a function of electrospun fiber hydrophilicity. Subsequently, the efficacy of the electrospun platform to sort the cancer cells from a mixed population of the primary human keratinocytes and fibroblasts via applied shear stress was assessed. Additionally, the viability of the cells after exposure to shear stress and subsequent removal from the growth surface was quantified to ensure that the sorted cancer cells may still be used for subsequent downstream analyses.

In an aspect, provided is an apparatus or device for sorting cells. The cells may be sorted without the need to label the cells prior to sorting. The device may include polymer nanofibers treated with gaseous plasma. In some embodiments, the nanofibers comprise at least one of polycaprolactone (PCL), collagen, polystyrene (PS), polyethersulfone (PES), polylactic acid (PLA), and polyethylene terephthalate (PET). In some embodiments, the nanofibers comprise PCL. In some embodiments, the nanofibers comprise collagen. The nanofiber composition may be chosen and optimized depending on the type of cancer cells to be sorted. For example, cells with moderate to high metastatic potential have a low strength of adhesion compared to non-metastatic cancer cells. Cells with moderate to high metastatic potential have an even lower strength of adhesion compared to non-cancer cells. Collagen may result in fibers with increased adhesivity relative to PCL fibers. As such, nanofibers may comprise PCL to sort cancer from non-cancer cells. Nanofibers may comprise collagen to sort metastatic cancer cells from non-metastatic cancer cells. In some embodiments, the gaseous plasma comprises at least one of CF₄, oxygen, argon, nitrogen, and air. In some embodiments, the gaseous plasma comprises CF₄.

The nanofibers may have a diameter of at least about 50 nm, at least about 55 nm, at least about 60 nm, at least about 65 nm, at least about 70 nm, at least about 75 nm, at least about 80 nm, at least about 85 nm, at least about 90 nm, at least about 95 nm, at least about 100 nm, at least about 120 nm, at least about 140 nm, at least about 160 nm, at least about 170 nm, at least about 180 nm, at least about 200 nm, at least about 250 nm, at least about 300 nm, at least about 350 nm, or at least about 400 nm. The nanofibers may have a diameter of less than about 500 nm, less than about 450 nm, less than about 400 nm, less than about 350 nm, less than about 300 nm, less than about 250 nm, less than about 200 nm, less than about 180 nm, less than about 160 nm, less than about 140 nm, less than about 120 nm, or less than about 100 nm. The nanofibers may have a diameter of about 50 nm to about 500 nm, about 50 nm to about 200 nm, about 75 nm to about 400 nm, or about 100 nm to about 300 nm. As used herein, diameter broadly refers to cross-sectional width or thickness, regardless of the cross-sectional shape (e.g., circular or other shape) of the nanofibers.

The nanofibers may be associated with a planar surface. The nanofibers may be directly spun onto glass, PS, PET, or polyethylene substrates. The nanofibers may also be adhered to these substrates, post-spinning with silicone, fibrin, or acrylic glue. As used herein, “associate” includes a range of interactions that this term covers, including, but not limited to, electrostatic, covalent, hydrostatic, ionic, adhesion-based, magnetic, hydrophobic, or hydrophilic interactions. In some embodiments, the planar surface comprises glass or polymer.

The cells being sorted can be from any suitable source. For example, cells may be from a sample from a subject. A subject can be an animal, a vertebrate animal, a mammal, a rodent (e.g. a guinea pig, a hamster, a rat, a mouse), murine (e.g. a mouse), canine (e.g. a dog), feline (e.g. a cat), equine (e.g. a horse), a primate, simian (e.g. a monkey or ape), a monkey (e.g. marmoset, baboon), an ape (e.g. gorilla, chimpanzee, orangutan, gibbon), or a human. In some embodiments, the subject is a mammal. In further embodiments, the mammal is a human.

As used herein, the term “sample” or “biological sample” relates to any material that is taken from its native or natural state, so as to facilitate any desirable manipulation or further processing and/or modification. A sample or a biological sample can comprise a cell, a tissue, a fluid (e.g., a biological fluid), a protein (e.g., antibody, enzyme, soluble protein, insoluble protein), a polynucleotide (e.g., RNA, DNA), a membrane preparation, and the like, that can optionally be further isolated and/or purified from its native or natural state. A “biological fluid” refers to any a fluid originating from a biological organism. Exemplary biological fluids include, but are not limited to, blood, serum, and plasma. A biological fluid may be in its natural state or in a modified state by the addition of components such as reagents, or removal of one or more natural constituents (e.g., blood plasma). A sample can be from any tissue or fluid from an organism. In some embodiments, the sample is a biopsy. In some embodiments, the sample comprises tissue from the breast, digestive tract, lung, liver, kidney, brain, lip, mouth, esophagus, urinary bladder, prostate, vagina, and/or cervix. In some embodiments the sample is from a tissue that is part of, or associated with, the breast of the organism. In some embodiments, the sample may be tissue from a neoplasm. A neoplasm may include cancer. In some embodiments, the sample may be cancerous tissue or from a tumor. In some embodiments, the sample may comprise tissue surrounding cancerous tissue or a tumor. In some embodiments, the sample may comprise tissue surrounding or around the perimeter of cancerous tissue or a tumor that was surgically excised.

In some embodiments, the plurality of cells being sorted comprises a mixed population of cell types. In some embodiments, the plurality of cells being sorted comprises a mixed population of cancer cells and non-cancer cells. In some embodiments, the plurality of cells being sorted comprises a mixed population of metastatic cancer cells and non-metastatic cancer cells. A cell may be a normal or healthy cell. A cell may be a neoplasatic cell. A cell may be a cancer cell. Cancer may include a carcinoma, an adenoma, a melanoma, a sarcoma, a lymphoma, a myeloid leukemia, a lymphatic leukemia, a blastoma, a glioma, an astrocytoma, a mesothelioma, or a germ cell tumor. Cancer may include cancer of the colon, rectum, cervix, skin, epithelium, muscle, kidney, liver, lymph, bone, blood, ovary, uterine, prostate, lung, brain, or breast.

In other aspects, provided are methods of sorting cells in a composition. The method may include providing a substrate comprising polymer nanofibers that have been pretreated with a gaseous plasma, as described above. The method may further include contacting the polymer nanofibers with a composition comprising a plurality of cells, and applying a force to the polymer nanofibers.

Applying a force to the polymer nanofibers may include applying a fluid flow. The fluid flow may be applied with a force of at least about 5 dynes/cm², at least about 10 dynes/cm², at least about 15 dynes/cm², at least about 20 dynes/cm², at least about 25 dynes/cm², at least about 30 dynes/cm², at least about 35 dynes/cm², at least about 40 dynes/cm², at least about 45 dynes/cm², at least about 50 dynes/cm², at least about 60 dynes/cm², at least about 70 dynes/cm², at least about 80 dynes/cm², at least about 90 dynes/cm², at least about 100 dynes/cm², at least about 120 dynes/cm², at least about 140 dynes/cm², at least about 160 dynes/cm², at least about 180 dynes/cm², or at least about 200 dynes/cm². The fluid flow may be applied with a force of less than about 500 dynes/cm², less than about 450 dynes/cm², less than about 400 dynes/cm², less than about 350 dynes/cm², less than about 300 dynes/cm², less than about 250 dynes/cm², less than about 200 dynes/cm², less than about 180 dynes/cm², less than about 160 dynes/cm², less than about 140 dynes/cm², less than about 120 dynes/cm², or less than about 100 dynes/cm². The fluid flow may be applied with a force of about 5 dynes/cm² to about 500 dynes/cm², about 50 dynes/cm² to about 450 dynes/cm², or about 100 dynes/cm² to about 400 dynes/cm². In some embodiments, the fluid flow is applied with a force of about 5 dynes/cm² to about 500 dynes/cm². In some embodiments, the fluid flow is applied with a force of about 100 dynes/cm² to about 400 dynes/cm². The magnitude of the force applied to the device may be chosen and optimized depending on the type of cancer cells (i.e., the strength of adhesion of the cell) to be sorted.

The force may be applied to the polymer nanofibers for a time period of at least about 1 min, at least about 2 min, at least about 3 min, or at least about 4 min. The force may be applied to the polymer nanofibers for a time period of less than about 10 min, less than about 8 min, less than about 6 min, or less than about 4 min. The force may be applied to the polymer nanofibers for a time period of about 1 min to about 10 min, about 2 min to about 8 min, or about 3 min to about 6 min. In some embodiments, the force is applied for about 1 min to about 10 min. In some embodiments, the force is applied for about 2 min to about 5 min. The time period of exposure to the applied force may be chosen and optimized depending on the type of cancer cells (i.e., the strength of adhesion of the cell) to be sorted.

As indicated above, the method may include contacting the polymer nanofibers with a composition. Contacting may include incubating the composition with the polymer nanofibers. The polymer nanofibers and the composition may be incubated together for at least about 30 min, at least about 40 min, at least about 50 min, at least about 60 min. The polymer nanofibers and the composition may be incubated together for less than about 24 hours, less than about 18 hours, less than about 12 hours, less than about 6 hours, less than about 4 hours, less than about 2 hours. The polymer nanofibers and the composition may be incubated together for a time period of about 30 min to about 24 hours, about 1 hour to about 18 hours, or about 2 hours to about 12 hours. In some embodiments, the polymer nanofibers and the composition are incubated together for about 30 min to about 24 hours. In some embodiments, the polymer nanofibers and the composition are incubated together for about 30 min to about 2 hours.

The method may further include collecting a first fraction of cells removed from the polymer nanofibers by the force applied to the polymer nanofibers. Collecting may include washing the first fraction from the device.

In some embodiments, a second fraction of cells remains adhered to the polymer nanofibers after applying the force. In some embodiments, when the composition comprises cancer cells and non-cancer cells, the first fraction may comprise at least about 60%, at least about 65%, at least about 70%, at least about 75%, at least about 80%, at least about 85%, at least about 90%, at least about 95%, or at least about 98% of the cancer cells. In some embodiments, the second fraction comprises at least about 60%, at least about 65%, at least about 70%, at least about 75%, at least about 80%, at least about 85%, at least about 90%, at least about 95%, or at least about 98% of the non-cancer cells.

In some embodiments, when the composition comprises metastatic cancer cells and non-metastatic cancer cells, the first fraction may comprise at least about 60%, at least about 65%, at least about 70%, at least about 75%, at least about 80%, at least about 85%, at least about 90%, at least about 95%, or at least about 98% of the metastatic cancer cells. The second fraction may comprise at least about 60%, at least about 65%, at least about 70%, at least about 75%, at least about 80%, at least about 85%, at least about 90%, at least about 95%, or at least about 98% of the non-metastatic cancer cells.

In some embodiments, the cells in the first fraction are viable after collection. In some embodiments, the cells in the second fraction are viable after collection. In some embodiments, the method further comprises subsequently analyzing the cells in the first fraction with a technique selected from PCR, Western Blot, Northern Blot, Southern Blot, immunohistochemistry, or FACS.

In other aspects, provided are methods of making a device for sorting cells. The method may include applying a composition comprising at least one polymer onto a surface by electrospinning to form polymer nanofibers, and exposing the polymer nanofibers to a gaseous plasma to produce treated polymer nanofibers.

Electrospinning of the composition may be conducted at a rate of at least about 2 mL/hour, at least about 4 mL/hour, at least about 6 mL/hour, at least about 8 mL/hour, at least about 10 mL/hour, at least about 12 mL/hour, at least about 14 mL/hour, at least about 16 mL/hour, or at least about 18 mL/hour. Electrospinning of the composition may be conducted at a rate of less than about 25 mL/hour, less than about 22 ml/hour, less than about 20 ml/hour, less than about 18 mL/hour, or less than about 15 mL/hour. Electrospinning of the composition may be conducted at a rate of about 2 mL/hour to about 20 mL/hour, about 4 mL/hour to about 18 mL/hour, or about 10 mL/hour to about 15 mL/hour. Electrospinning of the composition may be conducted at an electric potential of at least about 8 kV, at least about 10 kV, at least about 12 kV, at least about 14 kV, at least about 16 kV, or at least about 18 kV. Electrospinning of the composition may be conducted at an electric potential of less than about 40 kV, less than about 35 kV, less than about 30 kV, less than about 25 kV, or less than about 20 kV. Electrospinning of the composition may be conducted at an electric potential of about 10 kV to about 30 kV, or about 12 kV to about 25 kV. In some embodiments, electrospinning of the composition is conducted at a rate of about 10 mL/hour to about 20 mL/hour and at an electric potential of about 10 kV to about 30 kV.

The polymer nanofibers may be exposed to the gaseous plasma at a plasma radio frequency of at least about 2 MHz, at least about 4 MHz, at least about 6 MHz, or at least about 8 MHz. The polymer nanofibers may be exposed to the gaseous plasma at a plasma radio frequency of less than about 20 MHz, less than about 18 MHz, less than about 16 MHz, or less than about 14 MHz. The polymer nanofibers may be exposed to the gaseous plasma at a plasma radio frequency of about 2 MHz to about 20 MHz, about 4 MHz to about 18 MHz, or about 6 MHz to about 16 MHz. The polymer nanofibers may be exposed to the gaseous plasma for a time period of at least about 30 sec, at least about 1 min, at least about 2 min, or at least about 3 min. The polymer nanofibers may be exposed to the gaseous plasma for a time period of less than about 30 min, less than about 25 min, less than about 20 min, less than about 15 min, less than about 10 min, less than about 8 min, less than about 5 min, or less than about 4 min. The polymer nanofibers may be exposed to the gaseous plasma for a time period of about 30 sec to about 30 min, about 1 min to about 20 min, about 1 min to about 10 min, or about 2 min to about 10 min. In some embodiments, the polymer nanofibers are exposed to the gaseous plasma for a period of more than 30 min. In some embodiments, the polymer nanofibers are exposed to the gaseous plasma at a plasma radio frequency of about 5 MHz to about 15 MHz and for a period of about 1 min to about 5 min.

The use of the terms “a” and “an” and “the” and similar references in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including but not limited to”) unless otherwise noted. All methods described herein can be performed in any suitable order unless otherwise indicated herein or otherwise clearly contradicted by context. The use of any and all examples, or exemplary language (e.g., “such as”) provided herein, is intended merely to illustrate aspects and embodiments of the disclosure and does not limit the scope of the claims.

### EXAMPLES

### Example 1

### Materials and Methods

Polycaprolactone Scaffolds

Electrospun scaffolds were prepared using a solution of 10 wt. % polycaprolactone (PCL; MW ˜65,000; Sigma-Aldrich, St. Louis, Mo.) in 1,1,1,3,3,3-hexafluoro-2-propanol (HFP; Oakwood Products, West Columbia, S.C.). HFP-PCL solutions were electrospun at a rate 10 mL/hour (kd Scientific, Holliston, Mass.) and an electrical potential of 20 kV (Glassman High Voltage, High Bridge, N.J.) onto glass slides or coverslips positioned on a grounding plate to a thickness of approximately 100 μm.

Plasma Surface Modification

As spun-PCL fibers were placed into a Harrick plasma cleaner (Harrick Plasma, Ithaca, N.Y., USA). Air plasma-treated samples were placed into the chamber under vacuum at 1000 mTorr, and a plasma radio frequency of 8-12 MHz for 2.5 minutes. Tetrafluoromethane (CF₄) plasma-treated samples were placed into the chamber under vacuum at 400 mTorr, with the same radio frequency and time as the air samples. After 2.5 minutes, samples were removed from the chamber and kept in a sealed container until use.

Scaffold Characterization

The morphology of the PCL fibers, pre- and post-plasma treating, was qualitatively assessed using scanning electron microscopy (SEM; FEI Quanta, Hillsboro, Oreg.). As-spun, air and plasma etched PCL scaffolds were affixed to aluminum SEM stubs using conductive carbon tape (Ted Pella, Reading, Calif.), and were subsequently sputter coated with gold to render the surface conductive. All samples were imaged in secondary electron mode at 5 kV.

Surface hydrophobicity was quantified using goniometry. PCL fibrous scaffolds were cut into 5×1 cm segments, plasma treated with air or CF₄ gas, as described previously, and water contact angle was immediately measured using a Kruss Easydrop DSA20 (Krüss, Hamburg, Germany) contact goniometer. A 300-μL drop of deionized water was placed on a dry area of the PCL fiber, and using the Easydrop software, water contact angle was measured using a sessile drop contact to surface measurement. Five measurements were made and the average±standard deviation recorded.

Cell Culture

Primary human breast fibroblasts and keratinocytes (passage 2) and MCF-7 breast cancer cells were maintained in a humidified incubator at 5% CO₂/95% air and 37° C. Fibroblasts and keratinocytes were maintained in Dulbecco's Modified Eagles Medium (DMEM; Sigma) supplemented with 4% fetal bovine serum (FBS; Invitrogen, Portland, Oreg.), 10 ng/mL epidermal growth factor (EGF; Peprotech, Rocky Hill, N.J.), 5 μg/mL insulin (Sigma), 0.5 μg/mL hydrocortisone (HC; Sigma), 100 μM ascorbic-acid-2-phosphate (Sigma) and 1% penicillin-streptomycin (PSF; Invitrogen), and Medium 153 (Sigma) supplemented with 0.2 vol. % bovine pituitary extract (Gemini Bioproducts, West Sacramento, Calif.), 1 ng/mL EGF, 5 μg/mL insulin, 0.5 μg/mL HC, and 1% PSF, respectively. MCF-7 cells were cultured in DMEM supplemented with 10% FBS, 5 μg/mL insulin, 3.51 mg/mL D-glucose (Sigma), and 1% PSF. Medium for all cells was changed every other day.

Cell Proliferation

Once each cell type reached approximately 70% confluence, cells were harvested from culture flasks using trypsin-ethylenediaminetetraacetic acid (EDTA) at a concentration of 2.65×10³ Units/mL trypsin+0.01% EDTA (Sigma) and inoculated onto 12-mm diameter, electrospun scaffolds at a density of 20,000 cells/cm² (6, 12-mm disks per group). At days 1, 3, 5, and 7, a 4 mm biopsy was removed from each sample {n=6 per group per time point) and cell proliferation was assessed using a CellTiter 96 AQᵤₑₒᵤₛ Non-reactive Cell Proliferation Assay (MTS) (Promega Corp.; Madison, Wis.). Briefly, each punch biopsy was incubated with medium manufacturer's protocol. Following this incubation, the medium was removed and its absorbance was read at 490 nm using a plate reader (Gemini Spectramax). Average absorbance±standard deviation was reported.

Confocal Microscopy

To quantify cell spreading as a function of surface modification and cell type, cells were harvested and inoculated onto electrospun scaffolds at a density of 50,000 cells/cm². PCL-cell constructs were removed from culture at 1, 3, 6, and 24 hours (n=4 per time point). Constructs were rinsed with phosphate buffered saline (PBS) three times for five minutes each, fixed in 4% paraformaldehyde in PBS for 1 hour and again rinsed twice with PBS. Fibroblast-PCL samples were stained with phalloidin (AlexaFluor phalloidin 488; Invitrogen) and DAPI (Invitrogen), while MCF-7 and keratinocyte-PCL samples were immunostained with basic cytokeratin (Invitrogen) and DAPI. All samples were imaged with an Olympus FV1000-Spectral Confocal microscope (Olympus, Center Valley, Pa.) at 20-63× optical magnification. Cell area (n≦100 per groups per time point) was measured using ImageJ and the average cell area (μm²)±standard deviation was reported.

Computational Modeling of Fluid Flow and Surface Shear in Nanofiber Parallel Plate Device

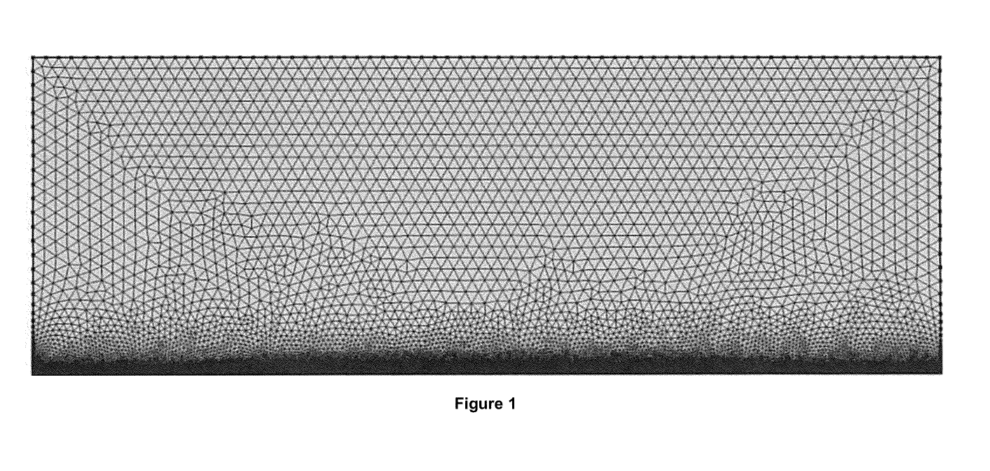

The fluid velocity profile and surface shear profile within the nanofiber parallel plate device was modeled to ensure uniformity in the image capture locations selected for the adhesion strength assay. First, surface roughness of the nanofiber platform was quantified using a Wyko NT9000 optical profilometer operating in vertical scanning interferometry (VSI) mode, with 20× objective and 1.0× field-of-view lens. The surface roughness value used to inform the model was averaged from three surface scans. Finite element fluid flow models were then constructed using Comsol 4.2a (Comsol, Inc., Burlington, Mass.) using a roughened lower surface to simulate the influence on the flow due to the presence of nanofibers on the base surface. To generate the surface roughness, a MATLAB script was developed to generate a series of thousands of circles, each of radius 2.789 μm having a variable separation between centers. The model chosen used 4 times the radius as the center-to-center separation. The circles were imported into COMSOL, and a rectangular block was generated for the flow channel. The Boolean Difference operator was used to subtract the circles from the area of the rectangular flow channel, giving a textured base surface. Several levels of triangular mesh refinement were used; ultimately the model with 493,236 degrees-of-freedom was chosen for the analysis presented here. As a result, the hemispheres were meshed coarsely, giving a saw-tooth texture for the base surface of the textured model used for Case 2 (FIG. 1). A surface velocity profile and a surface shear contour were calculated for an inlet velocity of 8.536×10⁻⁴ m/s, with no slip at the top or base surface and an outlet pressure of 0. Locations for cell imaging before and after shear were selected in areas having equivalent surface shear.

Strength of Adhesion

Prior to harvesting, cells for adhesion testing were stained with CellTracker™ Red CMTPX (Invitrogen), according to manufacturer's instructions, in order to quantify the relative percentage of cells remaining after testing. Each harvested cell type was inoculated onto individual electrospun slides at 20,000 cells/cm², incubated for one hour, and then tested for adhesion strength. Electrospun fiber-coated slides were imaged at equal intervals along the center line of the device, 12 mm from the inlet to 10 mm from the outlet port, using fluorescent microscopy (Nikon Eclipse LV150) before and after testing (7-10× images per sample, 6 samples/group). Slides were loaded into a parallel-plate device, and were exposed to a shear stress of 200, 275, or 350 dynes/cm² for 5 min each (n=6 per shear stress). Image analysis was performed to quantify cell number on each scaffold before and after shear exposure, and average percent remaining±standard error of the mean was reported.

Cell Sorting

Adhesion testing was then performed with the three cell types mixed and seeded onto slides to determine whether cancer cells could preferentially be removed from the mixed population as a function of adhesion strength. To identify each cell type, fibroblasts were stained with CellTracker™ Green CMFDA (Invitrogen) and keratinocytes with CellTracker™ Red CMTPX (Invitrogen) prior to inoculation, according to manufacturer's protocols. Unstained MCF-7s and live stained fibroblasts and keratinocytes were inoculated onto CF₄-treated scaffolds, incubated in blended culture medium for one hour, and exposed to a shear stress of 200 dynes/cm² for 5 min (non-shear exposed samples served as a control). All samples were fixed in 4% PFA, stained with DAPI and imaged using confocal microscopy (Olympus FVI 000-Spectral Confocal). MCF-7 cells were identified by presence of DAPI nuclear staining and absence of any additional staining. The number of fibroblasts, keratinocytes, and MCF-7s per field of view was quantified in non-exposed and sheared samples.

Post-Shear Viability

To determine if shear stress exposure reduced cell viability, cells were inoculated onto CF₄ treated scaffolds (n=6) and tested as described above with a shear stress of 350 dynes/cm². The cells removed from the scaffolds by shear flow were collected and inoculated onto a polystyrene 96-well plate at a density of 1,000 cells per well. Viability was quantified 1 and 24 hours after inoculation using an MTS assay, as previously described, and compared to cells which had not been exposed to shear stress. Brightfield images of the plated cells were taken at 1 hour post inoculation.

### Example 2

### PCL Scaffolds

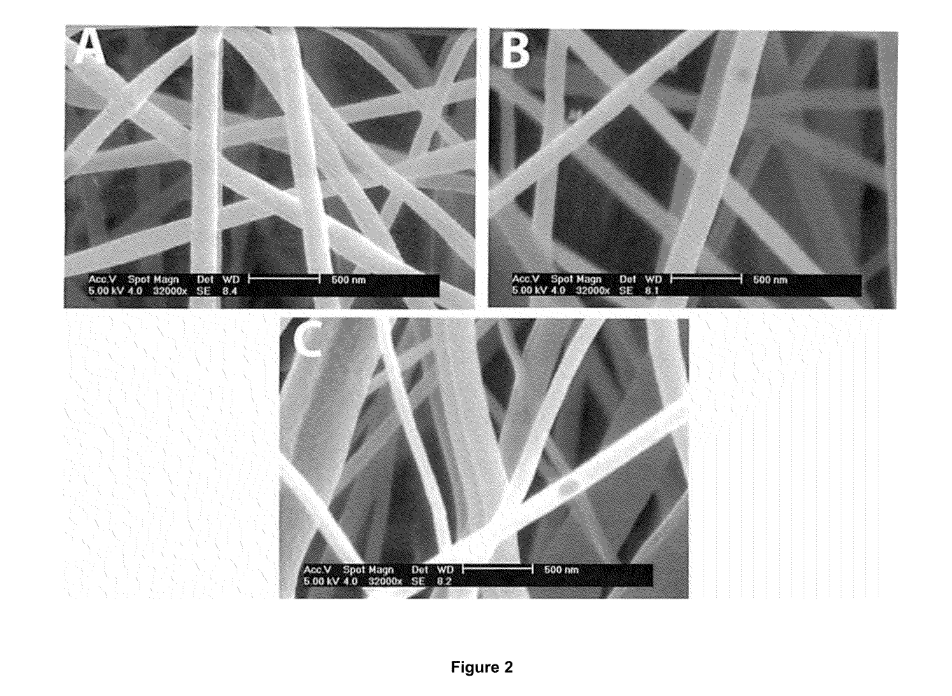

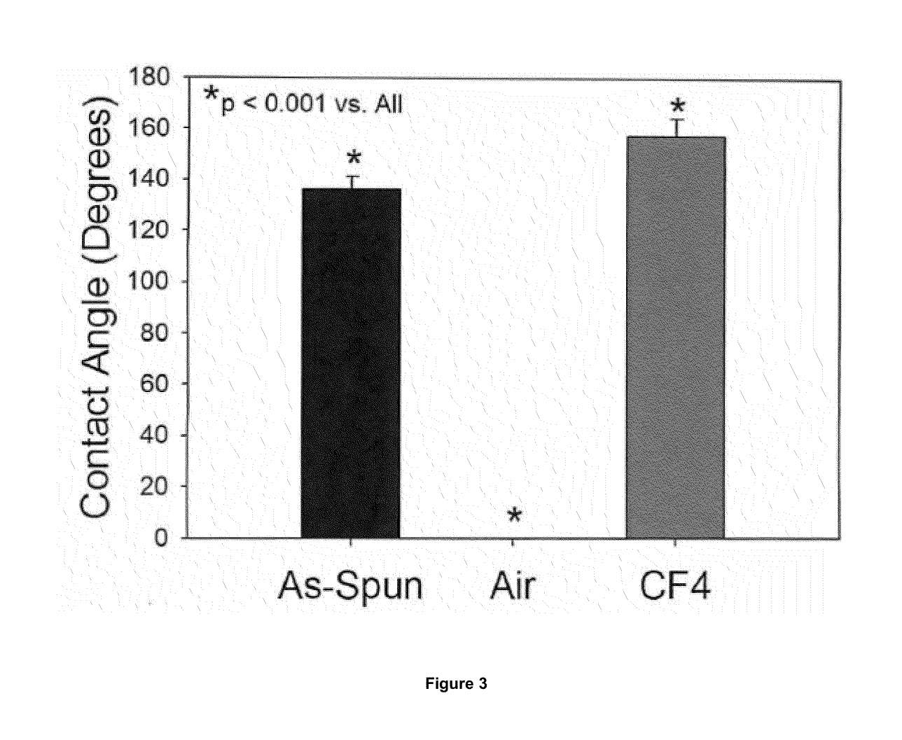

Utilizing scanning electron microscopy, no morphological differences between the as-spun and plasma-treated (air or CF₄) electrospun fibers were observed (FIG. 2). Fiber shape and topography suggested that plasma treatment had no effect on fiber morphology at either the micron or submicron level. In contrast, plasma treatment did have a significant effect on the hydrophilicity of the PCL fibers. Air and CF₄ plasma treatment resulted in contact angles of 0±0° and 157.6±6.9°, respectively (FIG. 3).

### Example 3

### Cell Viability and Spreading

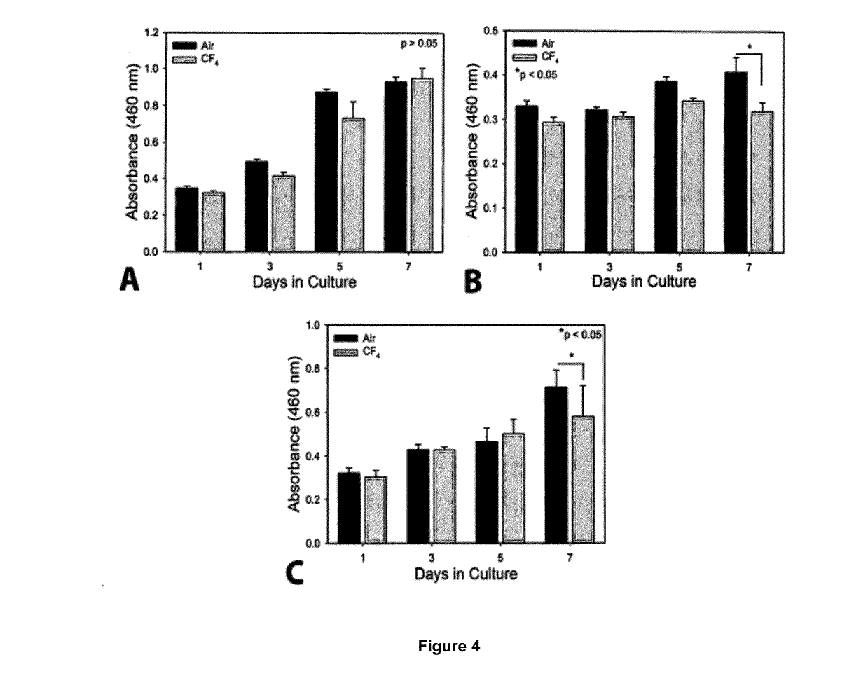

No statistically significant difference in proliferation was observed between cells cultured on the CF₄ plasma-treated and air plasma-treated PCL scaffolds at days 1-5 (FIG. 4). Keratinocyte and MCF-7 cell number was significantly lower on CF₄ plasma-treated scaffolds at day 7 (FIG. 4). Fibroblast and MCF-7 proliferation steadily increased from days 1-5 after which it plateaued. Keratinocyte proliferation, in contrast, was slow over the course of the 7-day culture period on both scaffold types (FIG. 4).

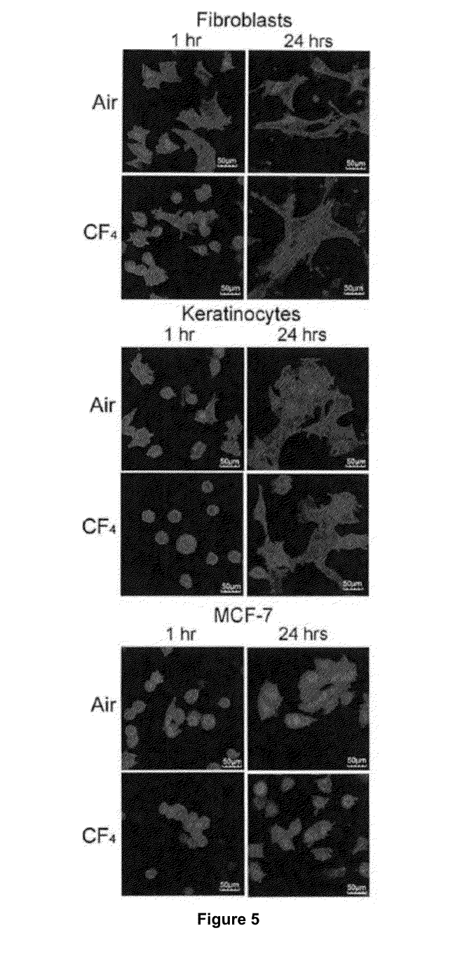

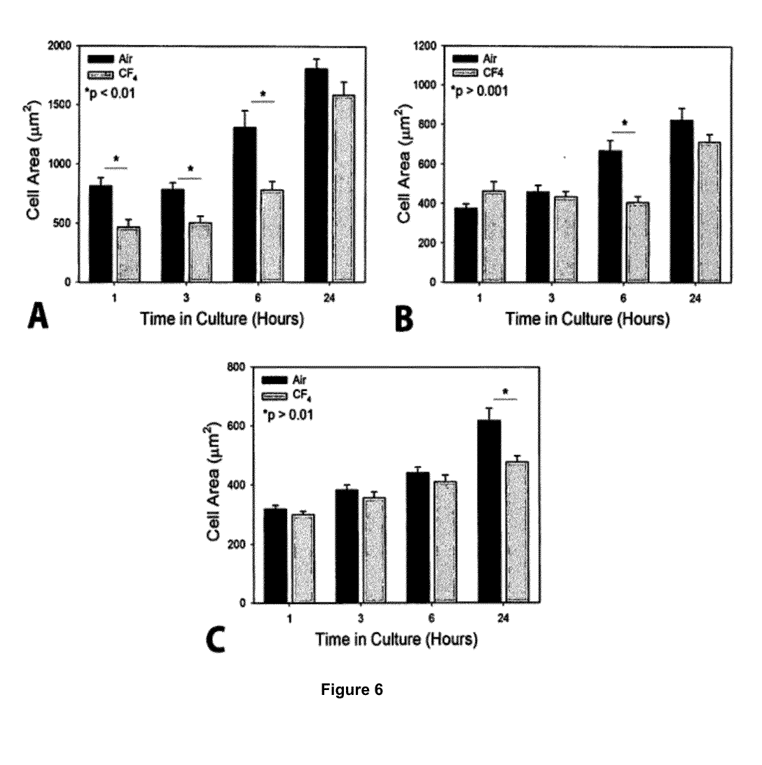

While scaffold hydrophobicity had minimal effects on cell proliferation, the wettability of the scaffolds significantly altered the speed and extent to which cells spread. In all cell types at 1 hour post inoculation, cells on air-plasma-treated scaffolds showed increased spreading compared to the CF₄ plasma-treated scaffolds. Fibroblasts on air treated scaffolds exhibited spread, extended filopodia, and had visible stress fibers 1 hour post inoculation. In contrast, fibroblasts on the CF₄ plasma-treated scaffolds at that time point were in the initial stages of attachment and most cells appeared rounded (FIG. 5). After 24 hours in culture, little difference in fibroblast morphology was observed. Keratinocyte cultures did not exhibit any differences in cell size (FIG. 6B) but a small increase in colony size was observed (FIG. 5). MCF-7 cells were approximately 30% larger on air treated scaffolds after 24 hours in culture and were in more tightly packed colonies than the CF₄-treated scaffold group.

### Example 4

### Strength of Adhesion

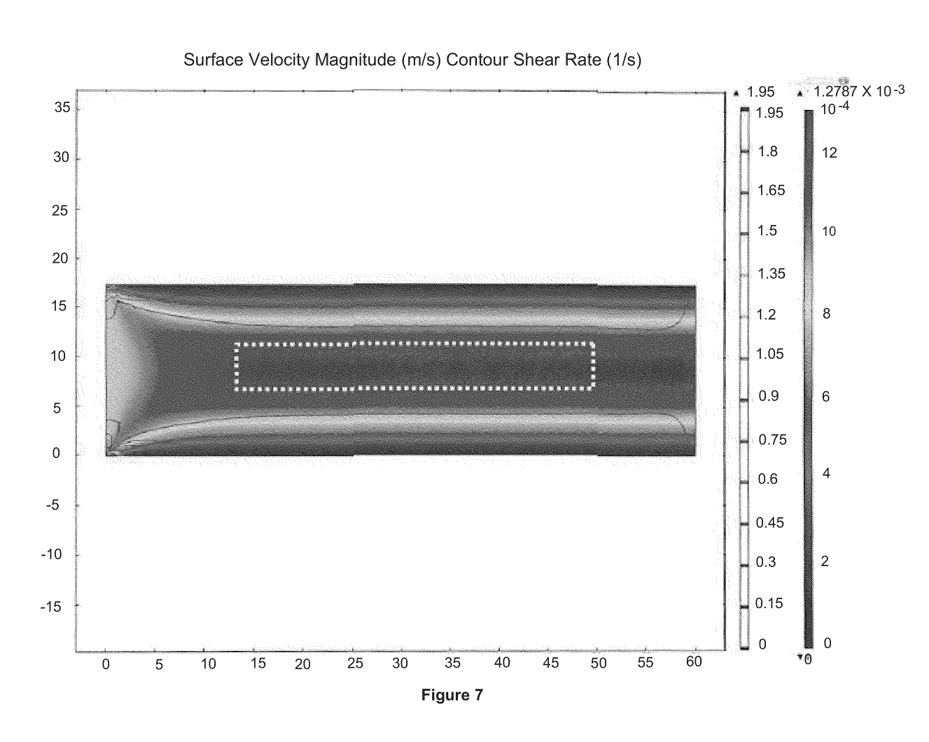

The finite element analysis results, shown as color contours representing velocity and shear rate (FIG. 7), indicate that the device generated a maximum level of surface fluid velocity and surface shear starting 9 mm from the inlet and traveling down the center line of the device to the outlet. Within this region, a uniform area of shear rate and fluid velocity can be seen (FIG. 7, white dashed line). All images for the strength of adhesion were collected from this region.

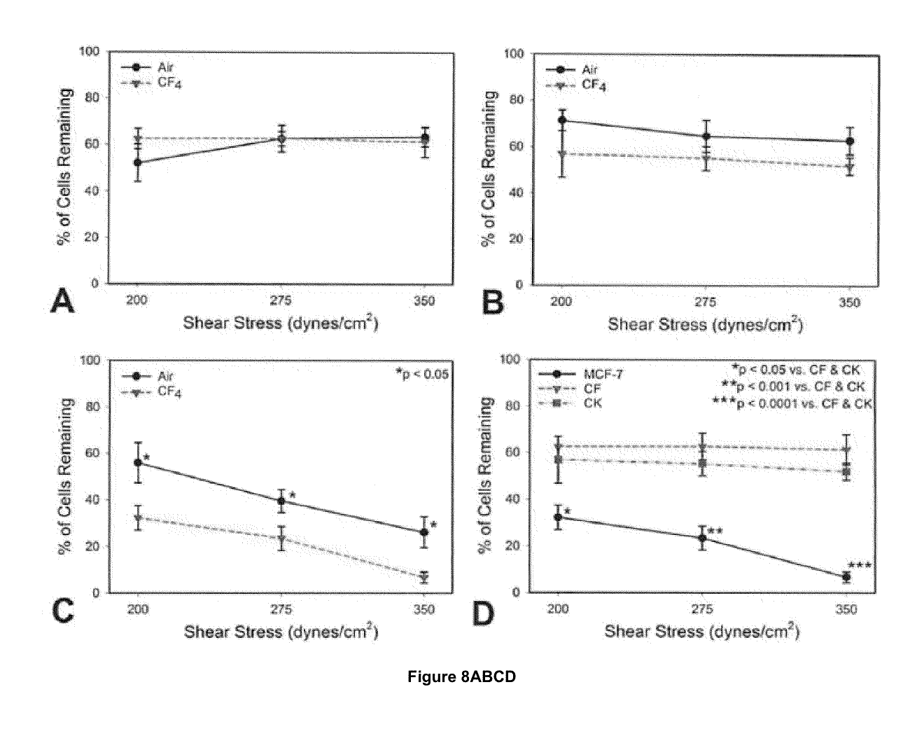

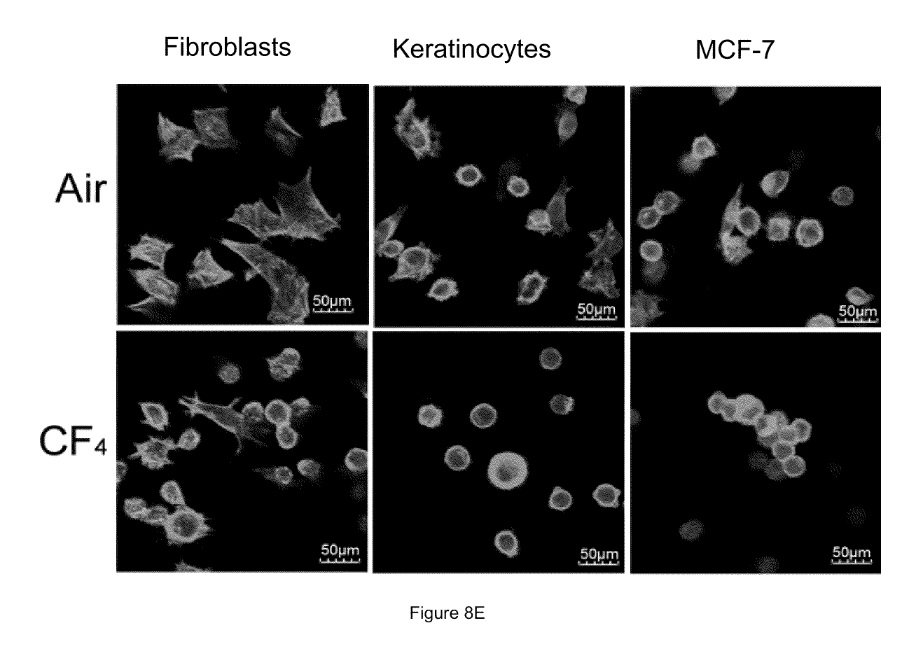

For fibroblasts and keratinocytes, no significant difference in strength of adhesion was observed between cells cultured on the air or CF₄ plasma-treated PCL scaffolds and the percent of cells remaining was relatively constant across the three values of shear stress (FIG. 8A-B). MCF-7 cells, however, showed a significant decrease in cell adhesion on CF₄ plasma-treated scaffolds as compared with air plasma-treated scaffolds. The CF₄ group exhibited an average of 19.7% fewer cells remaining than the air group after shear stress exposure. (FIG. 8C). Additionally, with increasing shear stress from 200 to 350 dynes/cm₂, cell adhesion decreased from 55.8% to 26.1% cells remaining for air treated samples and from 32.2% to 6.6% cells remaining for CF₄ plasma-treated samples (FIG. 8C). Comparing the retention of the three cell types on CF₄ plasma-treated substrates, significant differences were found between MCF-7 cancer cells and the two primary normal tissue cells (FIG. 8D). The largest difference was found after exposure to 350 dynes/cm², where the retention rates for fibroblasts, keratinocytes, and MCF-7 cells were 61.3%, 51.9%, and 6.6%, respectively. As shown in FIG. 8E, no macroscopic change in fiber morphology was observed as a result of the plasma modification process. Plasma modification did significantly alter the wetting behavior of the fibers, making the normally hydrophobic PCL hydrophilic after exposure to air plasma. The CF₄ plasma modification increased the hydrophobicity of the fibers. All cells shown in FIG. 8 are from human breast tissue. Both the fibroblasts (CF) and keratinocytes (CK) were primary cells from surgical discard tissue. No significant change in viability on the air and plasma treated surface was observed up to 5 days, as measured by an MTS viability assay.

### Example 5

### Cell Sorting

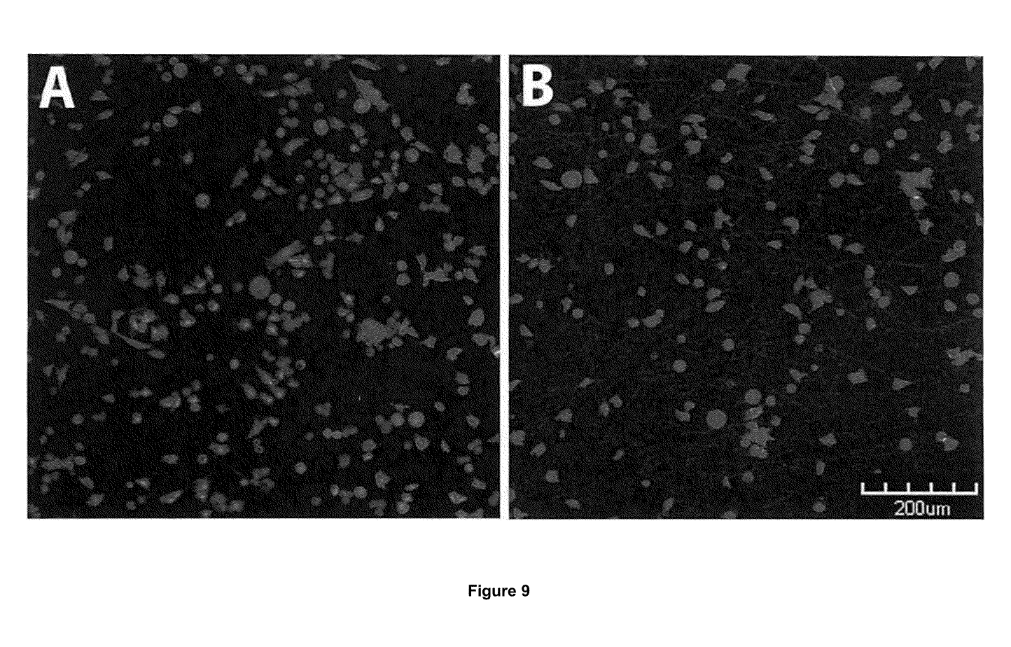

Equivalent numbers of fibroblast, keratinocytes, and MCF-7 cells were inoculated into the device and incubated for an hour. A set of samples was stained and imaged with no shear stress to assess the quantities of cells on the nanofibers before shear stress was applied. In addition, a set of samples was stained after the nanofibers were exposed to shear stress, in order to quantify the cells remaining after shearing. Confocal images of the mixed cell population on CF₄ plasma-treated substrates after exposure to 350 dynes/cm² revealed that a large percentage of fibroblasts and keratinocytes remained (FIG. 9B) compared to those before shear (FIG. 9A), approximately 74% and 57%, respectively. However, the shear-exposed substrate was almost completely devoid of MCF-7 cells, with an average of only 0.7% of MCF-7 cells remaining.

### Example 6

### Post-Shear Viability

PCL nanofibers were electrospun onto a glass slide and treated with CF₄ plasma to generate a 3D cell sorting device as described above. To examine whether exposure to shear stress altered the viability of the MCF-7 cells, MCF-7s were inoculated onto the device, incubated for 1 hour, and then exposed to 200 or 350 dynes/cm² shear stress. In each experiment, cells that were removed from the device by shear were collected, spun down, and replated. The replated cells were cultured for 1 and 24 hours, and a MTS viability assay was run. The results for cells removed by shear stress were compared to results for control MCF-7s which had not been exposed to shear stress. The data indicated that the shear did not harm the viability of the cells and that these collected cells could be used for downstream experiments, such as susceptibility to different chemotherapeutic drugs.

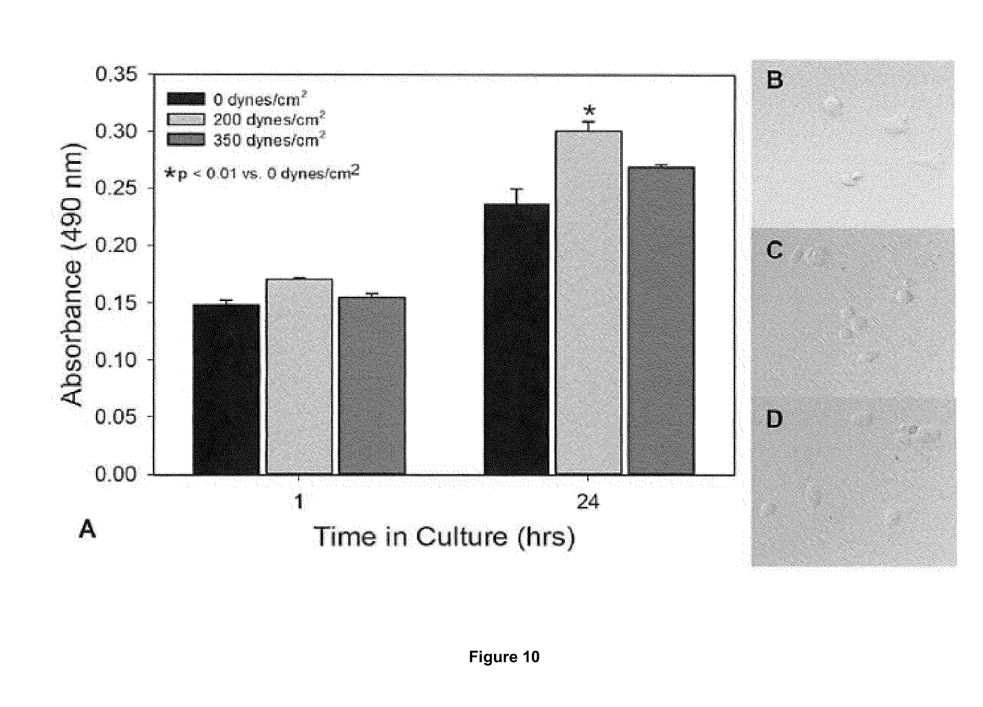

MCF-7 cells removed from CF₄ plasma-treated electrospun substrates by shear stresses of 200 and 350 dynes/cm² and MCF-7 cells plated directly without shear exposure showed no significant differences in metabolic activity either one or 24 hours post inoculation (FIG. 10A). Additionally, no significant difference in cell shape was observed between the control and shear conditions (FIG. 10B-D).

### Example 7

### 3D Cell Sorting Device with PCL

PCL nanofibers were electrospun onto a glass slide to generate a 3D cell sorting device as described above. The layer of nanofibers was approximately 5-10 fiber layers thick. As the fibers were nanometric in size and closely spaced, the cells adhered to the upper surfaces of the “scaffold.” Approximately 150,000 cells were incubated on the slide within the gasket material for 1 hour. The cells included primary human breast fibroblasts, primary human breast keratinocytes, and MCF-7 breast cancer cells. The cells were live stained to facilitate imaging and quantification and then exposed to shear stress via fluid motion for 5 minutes. The number of cells on the device was then counted following shear stress exposure.

### Example 8

### 3D Cell Sorting Device with Collagen

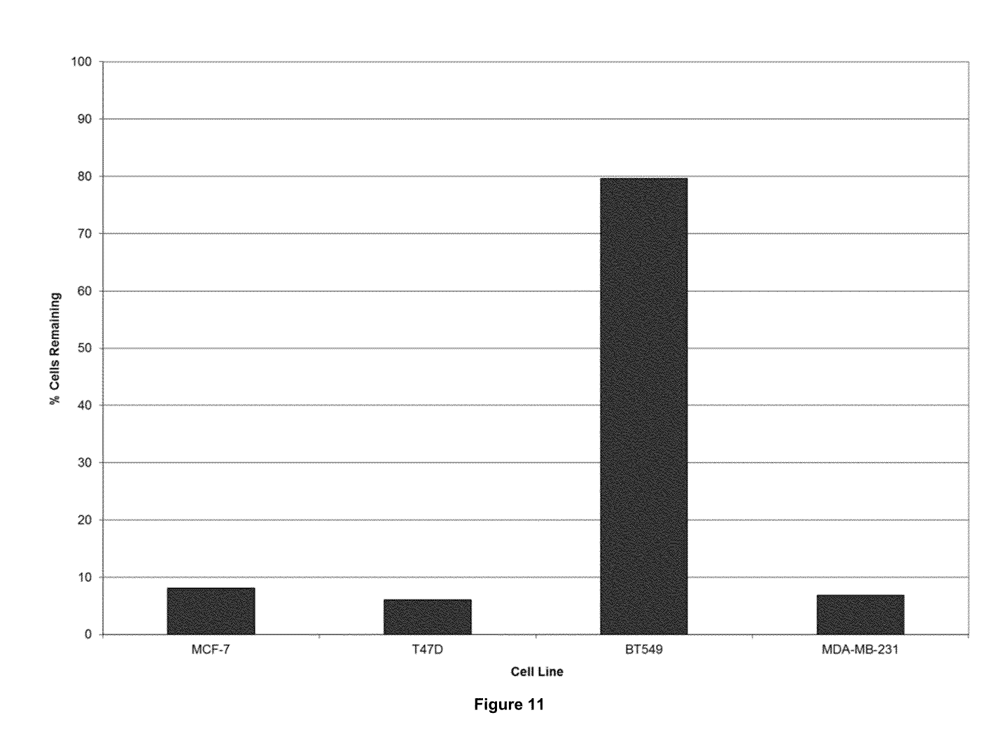

A 3D device was generated with collagen as the polymer, treated with CF₄. The collagen fibers were approximately 100 nm in diameter, and the fibers were approximately 5-10 fibers thick on the surface. Cells were incubated with the device for 1 hour and exposed to shear stress of 300 dynes/cm² for 5 min. As shown in FIG. 11, a portion of cells remained adhered to the fibers after shear stress of 300 dynes/cm². The collagen fibers provided increased adhesivity.

We claim:

1. An apparatus for sorting cells, the device comprising polymer nanofibers treated with gaseous plasma.

2. The apparatus of claim 1, wherein the nanofibers comprise at least one of polycaprolactone (PCL) and collagen.

3. The apparatus of claim 1, wherein the gaseous plasma comprises at least one of CF₄, oxygen, argon, nitrogen, and air.

4. The apparatus of claim 1, wherein the nanofibers have a diameter of about 50 nm to about 500 nm.

5. The apparatus of claim 1, wherein the nanofibers are associated with a planar surface.

6. The apparatus of claim 5, wherein the planar surface comprises glass or polymer.

7. A method of sorting cells in a composition, the method comprising:
providing a substrate comprising polymer nanofibers that have been pretreated with a gaseous plasma;
contacting the polymer nanofibers with a composition comprising a plurality of cells; and
applying a force to the polymer nanofibers.

8. The method of claim 7, wherein the substrate comprises a planar surface.

9. The method of claim 7, wherein the nanofibers comprise at least one of polycaprolactone (PCL) and collagen.

10. The method of claim 7, wherein the gaseous plasma comprises at least one of CF₄, oxygen, argon, nitrogen, and air.

11. The method of claim 7, wherein the nanofibers have a diameter of about 50 nm to about 500 nm.

12. The method of claim 7, wherein the plurality of cells comprises a mixed population of cancer cells and non-cancer cells.

13. The method of claim 7, wherein the plurality of cells comprises a mixed population of metastatic cancer cells and non-metastatic cancer cells.

14. The method of claim 7, wherein applying a force comprises applying a fluid flow.

15. The method of claim 14, wherein the fluid flow is applied with a force of at least about 5 dynes/cm².

16. The method of claim 7, wherein the force is applied for about 1 min to about 10 min.

17. The method of claim 7, wherein contacting comprises incubating the composition with the polymer nanofibers.

18. The method of claim 17, wherein the polymer nanofibers and the composition are incubated together for at least about 30 min.

19. The method of claim 7, further comprising collecting a first fraction of cells removed from the polymer nanofibers by the force applied to the polymer nanofibers.

20. The method of claim 19, wherein collecting comprises washing the first fraction from the device.

21. The method of claim 19, wherein a second fraction of cells remains adhered to the polymer nanofibers after applying the force,
wherein the composition comprises cancer cells and non-cancer cells, and
wherein the first fraction comprises at least about 60% of the cancer cells and the second fraction comprises at least about 60% of the non-cancer cells.

22. The method of claim 19, wherein a second fraction of cells remains adhered to the polymer nanofibers after applying the force,
wherein the composition comprises metastatic cancer cells and non-metastatic cancer cells, and
wherein the first fraction comprises at least about 60% of the metastatic cancer cells and the second fraction comprises at least about 60% of the non-metastatic cancer cells.

23. The method of claim 19, wherein the cells in the first fraction are viable after collection.

24. The method of claim 23, further comprising subsequently analyzing the cells in the first fraction with a technique selected from PCR, Western Blot, Northern Blot, Southern Blot, immunohistochemistry, or FACS.

25. A method of making a device for sorting cells, the method comprising:
applying a composition comprising at least one polymer onto a surface by electrospinning to form polymer nanofibers; and
exposing the polymer nanofibers to a gaseous plasma to produce treated polymer nanofibers.

26. The method of claim 25, wherein the polymer comprises at least one of polycaprolactone (PCL) and collagen.

27. The method of claim 25, wherein the gaseous plasma comprises at least one of CF₄, oxygen, argon, nitrogen, and air.

28. The method of claim 25, wherein the nanofibers have a diameter of about 50 nm to about 500 nm.

29. The method of claim 25, wherein the surface is planar and comprises glass or polymer.

30. The method of claim 25, wherein electrospinning of the composition is conducted at a rate of about 10 mL/hour to about 20 mL/hour and at an electric potential of about 10 kV to about 30 kV.

31. The method of claim 25, wherein the polymer nanofibers are exposed to the gaseous plasma at a plasma radio frequency of about 5 MHz to about 15 MHz and for a period of about 1 min to about 5 min.
